(19) United States
(12) Patent Application Publication
(10) Pub. No.: US 2007/0057888 A1
(43) Pub. Date: Mar. 15, 2007

(54) Pixel matrix and the pixel unit thereof

(76) Inventors: Che-Li Lin, Taipei City (TW); Chang-San Chen, Hsinchu (TW)

Correspondence Address: J.C. Patents, Inc., Suite 250, 4 Venture, Irvine, CA, 92618, US

(21) Appl. No.: 11/281,051

(22) Filed: Nov. 16, 2005

(30) Foreign Application Priority Data
Sep. 13, 2005 (TW) 94131429

(51) Int. Cl. G09G 3/36

(52) U.S. Cl. 345/92

(57) ABSTRACT

A pixel matrix used in a liquid crystal display, including a plurality of pixel units. Each pixel unit includes a storage unit, a first switch and a second switch. The storage unit determines the displayed gray scale of the pixel unit according to a pixel voltage applied to the storage unit. The first switch is coupled between a first data line, a first scan line and the storage unit. The first switch connects or disconnects the first data line with the storage unit, according to the state of the signal on the first scan line. On the other hand, the second switch is coupled between a second data line, a second scan line and the storage unit. The second switch connects or disconnects the second data line with the storage unit, according to the state of the signal on the second scan line.

### CROSS-REFERENCE TO RELATED APPLICATION

This application claims the priority benefit of Taiwan application serial no. 94131429, filed on Sep. 13, 2005. All disclosure of the Taiwan application is incorporated herein by reference.

### BACKGROUND OF THE INVENTION

1. Field of Invention

The present invention relates generally to a pixel matrix and the pixel units thereof. In particular, the present invention relates to a pixel matrix of liquid crystal display and the pixel units thereof.

2. Description of Related Art

Since thin-film transistor liquid crystal display panel (TFT LCD panel) uses liquid crystal as the material to control display, the driving voltage has to be periodically inverted, in order to prevent the polarization of the liquid crystal. Therefore, various methods of driving-inversion are developed. For example, dot inversion is a driving method being commonly used at present time.

Most large liquid crystal panels employ the design of direct current (DC) common voltage level (Vcom), resulting in a positive voltage level which is higher than the common voltage level and a negative voltage level which is lower than the common voltage level. Since the driving voltage of liquid crystal has to be inverted periodically, the swing of output voltage from the source driver is approximately twice in the size of common voltage. The voltage swing indicates the magnitude of the power consumption. In particular, large liquid crystal panel needs higher driving voltage, this problem of power dissipation becomes severer.

In order to reduce the power consumption of dot inversion driving, one solution is using a pixel matrix in specific design with a driving method in specific design, so that the swing of the output level of the source driver within a time period of the same frame can be reduced in half, as shown in FIG. 1.

FIG. 1 is drawing, schematically illustrating a structural diagram of the pixel matrix 100 in the solution above. Pixel matrix 100 is a simple example, having five data lines S1-S5, four scan lines G1-G4, and sixteen pixel units, among which the lower right pixel unit is indicated by 101. In the case of monochrome liquid crystal panel, every pixel unit is a pixel structure; in the case of color liquid crystal panel, every pixel unit is a sub-pixel (or dot) structure. Referring to FIG. 1, each pixel unit is connected to a scan line and a data line. The pixel units in the first and the third rows counting from the top are connected to the data line on the left side, while the pixel units in the second and the fourth rows are connected with the data line on the right side.

The source driver of pixel matrix 100 (not shown in the FIG. 1) exports the display data signals to the data lines S1-S5, the gate driver of pixel matrix 100 (also not shown in the FIG. 1) sequentially provides the scan lines G1-G5 with correspondent high level pulses (ON-level in FIG. 1). When the pixel unit receives the high level pulse, the pixel unit is turned on and is loaded with the data signal from the data line.

In the current frame period, the pixel units marked with “+” are on positive voltage driving, while the pixel units marked with “−” are on negative voltage driving. Data lines S1, S3, and S5 in this frame period output the positive voltage only, and data lines S2 and S4 in this frame period output the negative voltage only. Whenever the pixel units of the scan lines GI or G3 are to be loaded the data signals, the data line S1 provides the first pixel unit, counting from left, with the needed data signal; the data line S2 provides the second pixel unit with the needed data signal; and so on. On the other hand, whenever the pixel units of the scan line G2 or G4 are to be loaded with data signal, the data line S2 provides the first pixel unit with the needed data signal; the data line S3 provides the second pixel unit with the needed data signal, and so on.

In the next frame period, the polarities of all pixel units are respectively inverted, and the polarities of all the data lines S1-S5 are also inverted. Since each of the output terminal of the source driver only needs to provide either the positive voltage level or the negative voltage level in the same frame period, it is not necessary to switch between these two polarities. The swing of the output voltage level in the source driver can be reduced in half, and therefore the power consumption for the driving in dot inversion can be reduced.

The source driver described above is also called the data driver, and the gate driver described above is also called the scan driver.

There are, however, disadvantages in the solution illustrated in FIG. 1, one of which is the coupling phenomenon shown in FIG. 2: As an example, the upper left pixel unit in pixel matrix 100 is shown in FIG. 2. The pixel unit in FIG. 2 includes a thin-film transistor Q and a storage unit 201. There are several parasitic capacitors in the pixel matrix structure, such as C1, C2, C3, and C4 in FIG. 2. Due to the coupling effect of the parasitic capacitors, even with thin-film transistor Q being turned off, as the signal level on data line S1 changes, the pixel voltage level VP is accordingly varying. This causes the error in the displayed gray scale of the pixel units, even causing flickering.

Furthermore, the coupling phenomenon in FIG. 2 further causes the vertical crosstalk as shown in FIG. 3A and FIG. 3B. The liquid crystal panel is supposed to display an image 301, as shown in FIG. 3A, that is, an image with a black area 302 at the central region, and the other region of the image being in white. As a result, the displayed image looks like the image 311, as shown in FIG. 3B, where the additional gray areas 313 and 314 exist at upper and lower part of the black area 312. This is because the pixel units in the gray areas 313, 314 and the black area 312 are commonly using the same data lines. When the data signals of the black area 312 are passing through the data lines, the coupling effect causes the changes of the displayed gray scale in the areas 313 and 314, resulting in the gray color owing to the fact that human eyes average out the colors between white and black.

### SUMMARY OF THE INVENTION

The present invention provides a pixel unit, which reduces the power consumption of the dot inversion driving method and reduces the coupling effects and vertical crosstalk in the conventional technique.

The present invention also provides a pixel matrix, formed from foregoing pixel units above, which reduces the power consumption of the dot inversion driving method and reduces coupling effects and vertical crosstalk in the conventional technique.

In order to achieve the aforementioned and other goals, the present invention provides a pixel unit, used for a liquid crystal display, including a storage unit, a first switch, and a second switch. The storage unit determines the displayed gray scale of the pixel unit according to the voltage applied on the storage unit. The first switch is coupled between a first data line, a first scan line, and the storage unit. The first switch connects or disconnects the first data line with the storage unit, according to the state of the signal on the first scan line. The second switch is coupled between a second data line, a second scan line, and the storage unit. The second switch connects or disconnects the second data line with the storage unit, according to the state of the signal on the second scan line.

In one embodiment of the pixel unit described above, the first switch and the second switch are all thin-film transistors.

In one embodiment of the pixel unit described above, the first data line and the second data line have opposite polarities.

From another aspect, the present invention also provides a pixel matrix, used for liquid crystal display, having a plurality of pixel unit. Each pixel unit includes a storage unit, a first switch, and a second switch. The storage unit determines the displayed gray scale of the pixel unit according to the pixel voltage applied on the storage unit. The first switch is coupled between the first data line, the first scan line, and the storage unit, and connects or disconnects the first data line with the storage unit according to the state of the signal on the first scan line. The second switch is coupled between the second data line, the second scan line, and the storage unit, and connects or disconnects the second data line with the storage unit according to the state of the signal on the second scan line.

In another embodiment of the pixel matrix described above, the pixel unit adjacent to the left side of each pixel unit is also connected to the first data line, and the pixel unit adjacent to the right side of each pixel unit is also connected to the second data line.

In yet another embodiment of the pixel matrix described above, the first data line is placed adjacent to the second data line, and the first scan line is placed adjacent to the second scan line.

According to the embodiment of the present invention, the pixel unit of the present invention comprises two switches, which are connected respectively to two data lines with the opposite signal polarities. If the signals on these two data lines correspond to the same displayed gray scales, the coupling effects caused by these two switches will be canceled out by each other, resulting in no vertical crosstalk. On the other hand, if the signals on these two data lines correspond to different displayed gray scales, the coupling effects caused by these two switches will be at least partially canceled out, making the pixel voltage of the storage unit to be more stable. Therefore, the present invention not only can reduce the power consumption of the dot inversion driving, but also can reduce the coupling effects and vertical crosstalk in the conventional technique.

### BRIEF DESCRIPTION OF THE DRAWINGS

These and other exemplary embodiments, features, aspects, and advantages of the present invention will be described and become more apparent from the detailed description of exemplary embodiments when read in conjunction with accompanying drawings.

FIG. 1 is a drawing, schematically illustrating a pixel matrix in the conventional technique.

FIG. 2 is a drawing, schematically illustrating structure of a pixel unit of the conventional technique.

FIG. 3A and FIG. 3B are drawings, schematically illustrating the vertical crosstalk of displaying a picture in the conventional technique.

FIG. 4 is a structural diagram of a pixel unit according to an embodiment of the present invention.

FIG. 5 is a circuit diagram, schematically illustrating a pixel matrix according to an embodiment of the present invention.

### DESCRIPTION OF EMBODIMENTS

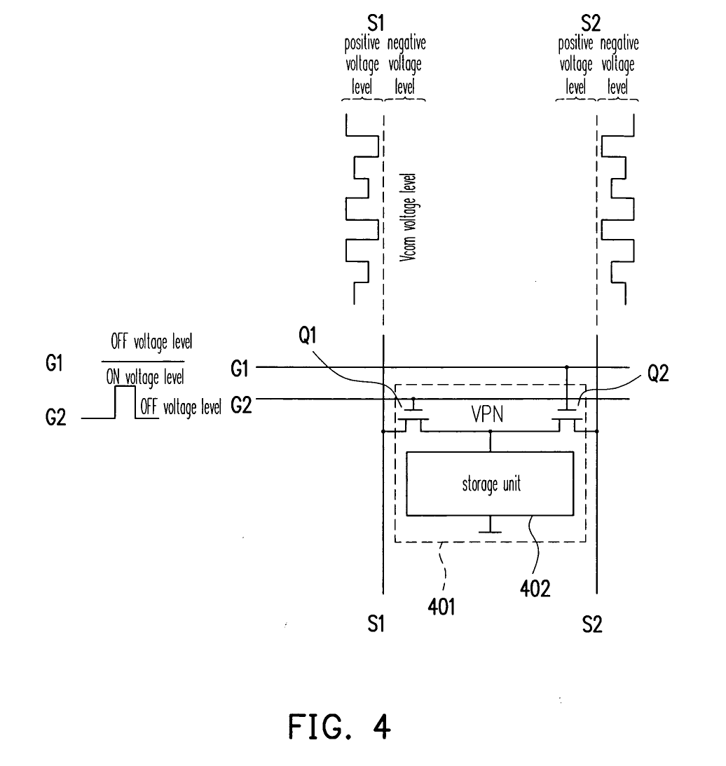

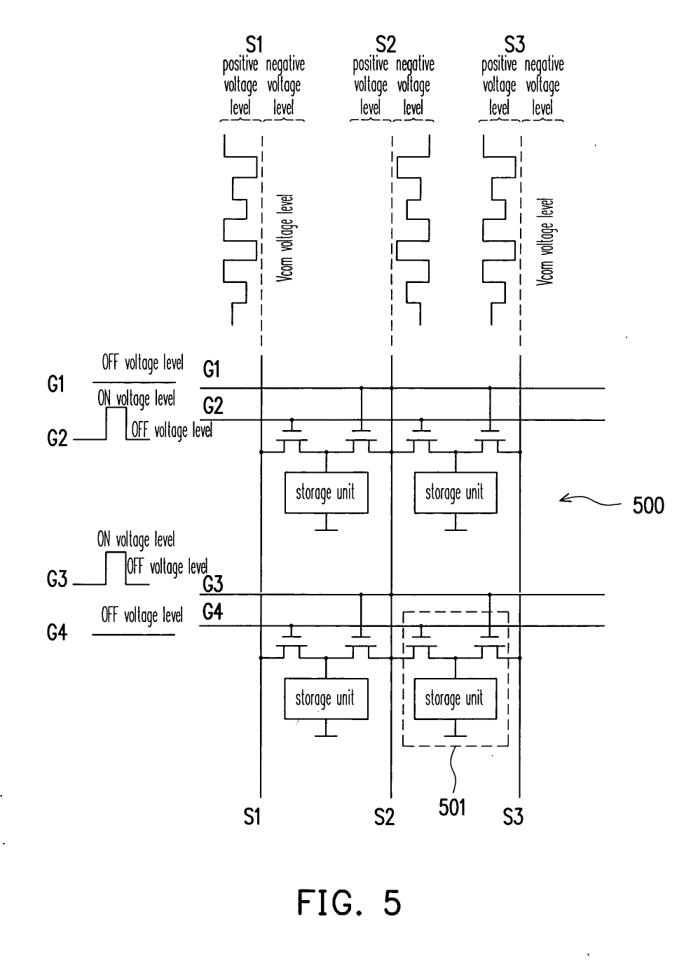

FIG. 4 and FIG. 5 in the following describe the pixel unit and the pixel matrix, according to the present invention.

First, FIG. 4 is a structural diagram of a pixel unit 401, according to an embodiment of the present invention. The pixel unit 401 can be a pixel or a sub-pixel of a liquid crystal display. The pixel unit 401 comprises a storage unit 402 and switches Q1, Q2. The storage unit 402 can determine the displayed gray scale of the pixel unit 401 according to the pixel voltage VPN applied thereon. The storage unit 402 of the embodiment basically includes a capacitor.

The switches Q1 and Q2 of the embodiment are two structurally identical thin-film transistors. Switch Q1 is coupled between the data line S1, the scan line G2, and the storage unit 402. The switch Q1 can connect or disconnect the data line S1 with the storage unit 402, according to the state of the signal on scan line G2. On the other hand, the switch Q2 is coupled between the data line S2, the scan line G1, and the storage unit 402. The switch Q2 can connect or disconnect the data line S2 with the storage unit 402, according to the state of the signal on scan line G1. In this embodiment, the switches Q1 and Q2 are in conducting when the voltage respectively on the connected scan line becomes high (ON in FIG. 4), and in opening when the voltage respectively on the connected scan line becomes low (OFF in FIG. 4). In fact, only the scan line G2 can have high voltage. That is to say, the pixel unit 401 can receive the data signal from the data line S1 only, and the switch Q2 is never conducting.

The scan lines G1 and G2 are all connected to the scan driver of the liquid crystal display (not shown in FIG. 4). The scan driver provides the scan lines GI and G2 with the scan signals. And the data lines S1 and S2 are connected to the data driver of the liquid crystal display (also not shown in FIG. 4). The data driver provided the data lines S1 and S2 with the data signals, needed to display an image. When using the dot inversion driving, since the data lines S1 and S2 are adjacent to each other in the pixel matrix, the signal polarities on the data lines S1 and S2 are always opposite. In other words, whenever the data line S1 has a positive voltage, the data line S2 has a negative voltage, and vice versa.

Because the switches Q1 and Q2 have the same structure, the parasitic capacitor between the pixel unit 401 and the data line S1, and the parasitic capacitor between the pixel unit 401 and the data line S2 are symmetrical. Whereas the signal levels on the data lines S1 and S2 are always opposite, the coupling effects caused by the data lines S1 and S2 can cancel each other out by at least a part. If the data signals of the data lines S1 and S2 correspond to the same displayed gray scale, the coupling effects can be canceled out entirely. In a similar way, the vertical crosstalk caused by the data lines S1 and S2 can be canceled out by each other.

In the following, FIG. 5 is a circuit diagram, schematically illustrating a pixel matrix 500, according to an embodiment of the present invention. The pixel matrix 500 comprises the data lines S1-S3 connected to the data driver ( not shown in FIG. 5 ) , the scan lines G1-G4 connected to the scan driver (also not shown in FIG. 5), and four pixel units, such as the lower right pixel unit 501. Every pixel unit has an identical structure to the pixel unit 401, as shown in FIG. 4, comprising two switches and one storage unit. When using the dot inversion driving, the adjacent data lines always have opposite signal voltages.

In pixel matrix 500, the neighboring pixel units in the same row are connected to the data line between the two pixel units described above. For example, the pixel unit 501 and the pixel unit at the left side of the pixel unit 501 are commonly connected to the data line S2. If there is still a pixel unit at the right side of the pixel unit 501, the pixel unit and the pixel unit 501 are commonly connected to the data line S3. In this embodiment, the two data lines connected to each pixel unit are adjacent to each other. In other words, there is no other data line between these two data lines. Also and, the two scan lines connected to each pixel unit are adjacent to each other.

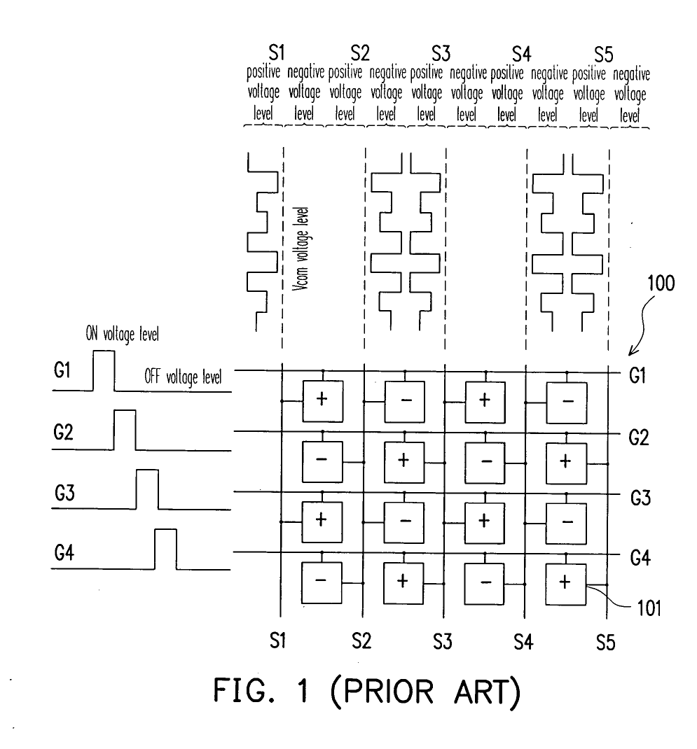

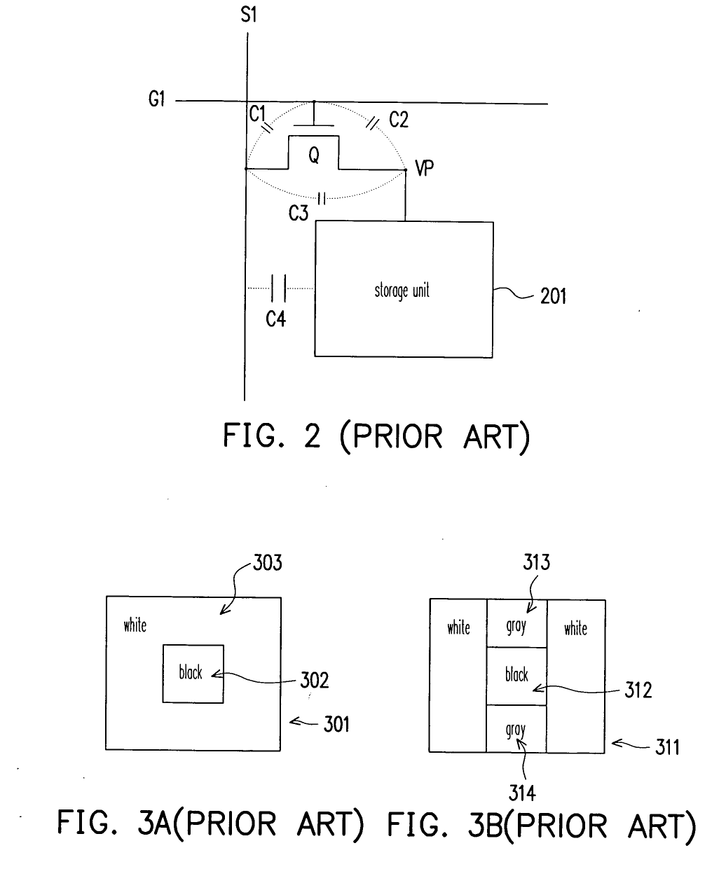

Every pixel unit of the pixel matrix 500 has two switches, and one of the switches is not connected. As shown in FIG. 5, only the scan lines G2 and G3 in the scan lines G1-G4 provide the effective scan signals. Therefore, the pixel units of the upper row are only effectively connected to the data line at the left side, and the pixel units of the lower row are effectively connected to the data line at the right side. Comparing FIG. 1 with FIG. 5, it is not difficult to see that the pixel matrix 500 can use the same driving method of the pixel matrix 100.

The pixel unit in the present invention is not limited by the connection scheme illustrated in FIG. 5. For instance, the scan lines connected to the two switches of each pixel unit can be swapped. For example in pixel unit 501, the left switch is connected to the scan line G3 and the right switch is connected to the scan line G4. On the other hand, the data lines connected to the two switches of each pixel unit can also be swapped. For example in pixel unit 501, the left switch is connected to data line S3 and the right switch is connected to data line S2. If it is necessary, the signals on the scan lines and/or the data lines have to be adjusted accordingly, in order to achieve the dot inversion driving as shown in FIG. 1. Those ordinarily skilled in the art can easily make the necessary modification upon reading the descriptions above.

Although FIG. 5 only shows four pixel units, the number of pixel units is not limited in the present invention. As shown in FIG. 5, every pixel unit of the pixel matrix 500 has an identical structure to be easily duplicated in the horizontal and vertical directions.

As a summary, the pixel unit of the present invention comprises two switches, which are connected to two data lines with opposite polarities, respectively. If the signals on these two data lines correspond to the same displayed gray scale, the coupling effects caused by these two switches will cancel each other out, resulting in no vertical crosstalk. On the other hand, if the signals on these two data lines correspond to different displayed gray scales, the coupling effects caused by these two switches can at least cancel each other out partially, making the pixel voltage applied on the storage unit to be more stable. Therefore, the present invention not only can reduce the power consumption of dot inversion driving, but also can reduce the coupling effects and vertical crosstalk of the conventional technique.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A pixel unit, used for a liquid crystal display, comprising:
a storage unit, determining a displayed gray scale of the pixel unit, according to the pixel voltage applied to the storage unit;
a first switch, coupled between a first data line, a first scan line, and the storage unit, connecting or disconnecting the first data line with the storage unit according to a state of a signal on the first scan line; and
a second switch, coupled between a second data line, a second scan line, and the storage unit, connecting or disconnecting the second data line with the storage unit according to a state of a signal on the second scan line.

2. The pixel unit of claim 1, wherein the pixel unit is a pixel or a sub-pixel of the liquid crystal display.

3. The pixel unit of claim 1, wherein the storage unit comprises at least one capacitor.

4. The pixel unit of claim 1, wherein the first switch and the second switch have an identical structure.

5. The pixel unit of claim 1, wherein the first switch and the second switch are thin-film transistors.

6. The pixel unit of claim 1, wherein the first data line and the second data line are connected to a data driver of the liquid crystal display.

7. The pixel unit of claim 1, wherein the first data line and the second data line have opposite signal polarities.

8. The pixel unit of claim 1, wherein the first scan line and the second scan line are connected to a scan driver of the liquid crystal display.

9. A pixel matrix, used for a liquid crystal display, comprising a plurality of pixel units, each one of the pixel units comprising:
a storage unit, determining a displayed gray scale of the pixel unit according to pixel voltage applied to the storage unit;
a first switch, coupled between a first data line, a first scan line, and the storage unit, connecting or disconnecting the first data line with the storage unit according to a state of a signal on the first scan line; and
a second switch, coupled between a second data line, a second scan line, and the storage unit, connecting or disconnecting the second data line with the storage unit according to a state of a signal on the second scan line.

10. The pixel matrix of claim 9, wherein a left pixel unit adjacent to a left side of the one of the pixel units is also connected to the first data line, and a right pixel unit adjacent to a right side of the one of the pixel units is also connected to the second data line.

11. The pixel matrix of claim 9, wherein each of the pixel units is a pixel or a sub-pixel of the liquid crystal display.

12. The pixel matrix of claim 9, wherein the storage unit comprises at least one capacitor.

13. The pixel matrix of claim 9, wherein the first switch and the second switch have an identical structure.

14. The pixel matrix of claim 9, wherein the first switch and the second switch are thin-film transistors.

15. The pixel matrix of claim 9, wherein the first data line and the second data line are connected to a data driver of the liquid crystal display.

16. The pixel matrix of claim 9, wherein the first data line is adjacent to the second data line.

17. The pixel matrix of claim 9, wherein the first data line and the second data line have opposite signal polarities.

18. The pixel matrix of claim 9, wherein the first scan line and the second scan line are connected to a scan driver of the liquid crystal display.

19. The pixel matrix of claim 9, wherein the first scan line is adjacent to the second scan line.
